(19) United States
(12) Patent Application Publication
(10) Pub. No.: US 2002/0097321 A1
(43) Pub. Date: Jul. 25, 2002

(54) Vehicle inspection camera utilizing infrared diodes

(76) Inventor: Richard L. McBride, Tierra Verde, FL (US)

Correspondence Address: LARSON AND LARSON, 11199 69TH STREET NORTH, LARGO, FL, 33773

(21) Appl. No.: 09/766,897

(22) Filed: Jan. 22, 2001

(51) Int. Cl. H04N 7/18

(52) U.S. Cl. 348/148; 345/8

(57) ABSTRACT

A vehicle inspection camera system is provided and includes an elongated rod having a video camera mounted on a distal end, a headgear unit having an eyepiece with a video screen mounted therein, and a battery belt pack. A video signal cable couples the video camera to the video screen. The battery belt pack includes a pouch in which a 12 volt DC battery is enclosed. The battery supplies power to the video camera and video screen. A plurality of infrared diodes are mounted around the video camera so that lens of the camera can capture an image in low or no light situations. The vehicle inspection camera system is used by positioning the camera underneath a vehicle and viewing its undercarriage through the eyepiece. The headgear unit is worn on the skull of the operator while battery belt pack is secured to the waist of the operator.

### BACKGROUND OF THE INVENTION

1. Field of the Invention

This invention relates to video cameras. More particularly, it relates to a video camera mounted on the end of an extendable device for inspecting areas which are difficult to view, such as, for example, the undercarriage of a vehicle.

2. Description of Prior Art

Video cameras are well known in the prior art. They come in many forms and sizes and can be used for a variety of purposes. The most common type of video camera is the hand held video camcorder used by individuals to record events such as family gatherings and the like. These type of devices are compact and employ a video lens, viewer and recorder. The user simply engages the power of the camera, views a scene (either through an eyepiece or a small “pop-out” LCD screen) and records the event on a self-contained tape recorder. The event can then be reviewed and watched at a later time either through the video camera or on a larger video screen (i.e., a television set).

Other known types of video cameras include security cameras. Typically, these cameras are employed in discrete locations such that the common person does not realize the camera's presence. These cameras can be connected to a video recorder so that the area being viewed can also be recorded in case an unwanted act occurs, such as, for example, a robbery. Security cameras such as these are found in hotels, grocery stores, department stores and casinos.

Other video cameras are used to view areas which a person can not typically see with the human eye due to the size of the area, the location of the area or other environmental concerns. An extreme example would be a camera used on a catheter which is inserted within an artery of a human body. These type of cameras are used to indicate whether an individual may have any blockage in an artery of the heart. A camera used for such a purpose must be extremely small. A related device is a camera which is used in dental applications such as that seen in U.S. Pat. No. 4,727,416. Other types of remote video cameras are used to view pipes and ducts. Cameras such as these are known in the prior art and can be seen in U.S. Pat. Nos. 3,739,089, 3,832,724, 3,885,091, 4,913,558. All of these devices and systems are employed for specific uses and are not adaptable for use in other locations and therefore are deficient. In other words, their configuration is dictated by their intended use.

In some instances, the location to be viewed is accessible by a person, but it is inconvenient for the person to view the location with the human eye. For instance, at the borders of countries, custom and immigration officials typically wish to inspect the vehicles crossing the border in which they control. This can be extremely burdensome due to the amount of traffic passing thereby. It is not uncommon to have thousands of vehicles crossing a single border check point, such as those seen in Southern California in the U.S.A. A border official, wishing to view the undercarriage of a vehicle, could get down on his hands and knees, however this would be burdensome to do for the thousands of vehicles per day crossing a typical border. It would therefore be advantageous to have a video camera device which would permit the inspection of the undercarriage of a vehicle by a person such as a border official. The device should allow the user to quickly and easily inspect the vehicle so as not to cause undue delay for the vehicle operator. Since it could be dark underneath a vehicle, it would be additionally advantageous to have a video camera viewing device which could illuminate a dark area so that the camera lens could see the dark area. Applicant is not aware of any such device. However, Applicant is aware of video camera viewing and night vision systems that employ infrared diode technology. Such can be seen in U.S. Pat. Nos. 5,309,230 and 5,781,243. Notwithstanding, these systems do not contemplate or teach, let alone disclose, a video camera viewing system for use in inspecting the undercarriage of a vehicle wherein infrared diodes are employed to illuminate the dark and remote location underneath the vehicle.

### SUMMARY OF THE INVENTION

I have invented a video camera system for use in viewing and inspecting the undercarriage of a vehicle. My device employs a video camera lens mounted on a head portion of an extendable rod. The rod has a pair of leg members separated by a knuckle portion permitting the rod to be positioned at varying angles. The camera lens has a set of infrared diodes mounted therearound for illuminating the area to be viewed in low light situations. The camera lens is powered by a battery pack which can be worn by the user on a belt. The system further includes headgear which includes a positionable eyepiece. The eyepiece is also powered by the battery pack. A video cable connects the camera lens to the eyepiece.

The viewing system is used by engaging power to the lens and eyepiece, placing the headgear on the user's head, positioning the eyepiece in front of one of the user's eyes and then extending the head portion of the vehicle inspection camera device underneath the vehicle. The user then moves the head portion, having the camera mounted thereon, around the undercarriage of the vehicle thereby inspecting the vehicle.

### BRIEF DESCRIPTION OF THE DRAWINGS

The invention may be best understood by those having ordinary skill in the art by reference to the following detailed description when considered in conjunction with the accompanying drawings in which:

FIG. 1 is a perspective view of a vehicle inspection video camera of the present invention;

FIG. 2 is a detail perspective view of the camera head portion employed with the novel vehicle inspection video camera;

FIG. 3 is a detail perspective of the eyepiece head gear employed with the vehicle inspection video camera;

FIG. 4 is a detail perspective of the battery belt and power and video signal adapter employed with the vehicle inspection video camera;

FIG. 5 is a rear perspective view of the power and video signal adapter;

FIG. 6 is a flow diagram illustrating the electrical components employed with the vehicle inspection video camera;

FIG. 7 is an exploded perspective view of the battery pack employed with the vehicle inspection video camera; and

FIG. 8 illustrates the vehicle inspection camera of the present invention being used to inspect the undercarriage of a vehicle.

### DETAILED DESCRIPTION OF THE INVENTION

Throughout the following detailed description, the same reference numerals refer to the same elements in all figures.

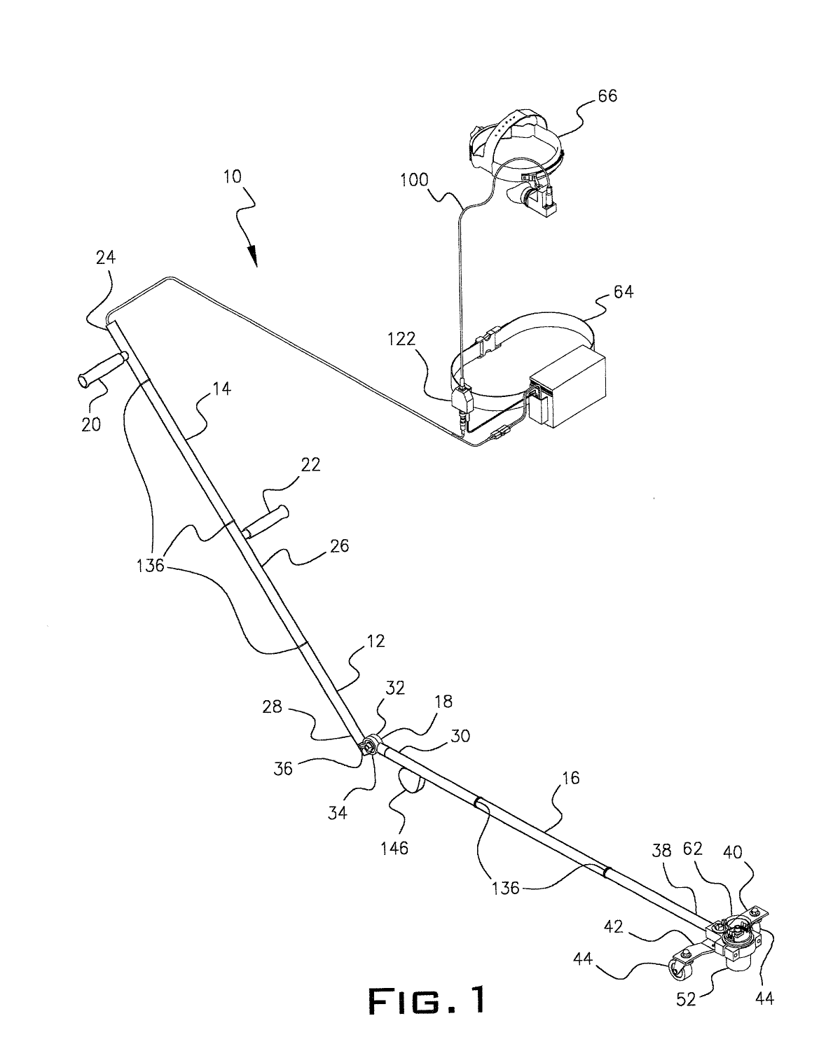

Referring to FIG. 1, a vehicle inspection camera device 10 is shown including an extendable rod 12 having an upper and lower leg member, 14 and 16 respectively, separated by an adjustable elbow 18. Rod upper leg member 14 has an upper and lower handle, 20 and 22 respectively, each extending at ninety degree angles from rod upper leg member 14 in opposing directions and on opposite sides thereof. Handles 20 and 22 are staggered such that upper handle 20 is positioned near a top end 24 of upper rod leg member 14, whereas handle 22 is positioned slightly therebelow generally at about a middle portion 26.

With continuing reference to FIG. 1, adjustable elbow 18, separating rod upper and lower leg members, 14 and 16, permits rod 12 to be positioned at varying angles from 0° to 180°. Elbow 18 is located at a bottom end 28 of rod upper leg member 14 and a first end 30 of rod lower leg member 16. Elbow 18 includes a pair of circular plates, 32 and 34, which mate by a set of teeth on one plate engaging a set of reciprocal grooves on the other plate. A wing nut 36 locks the teeth into the grooves when the desired angle between rod upper and lower leg members, 14 and 16, is chosen.

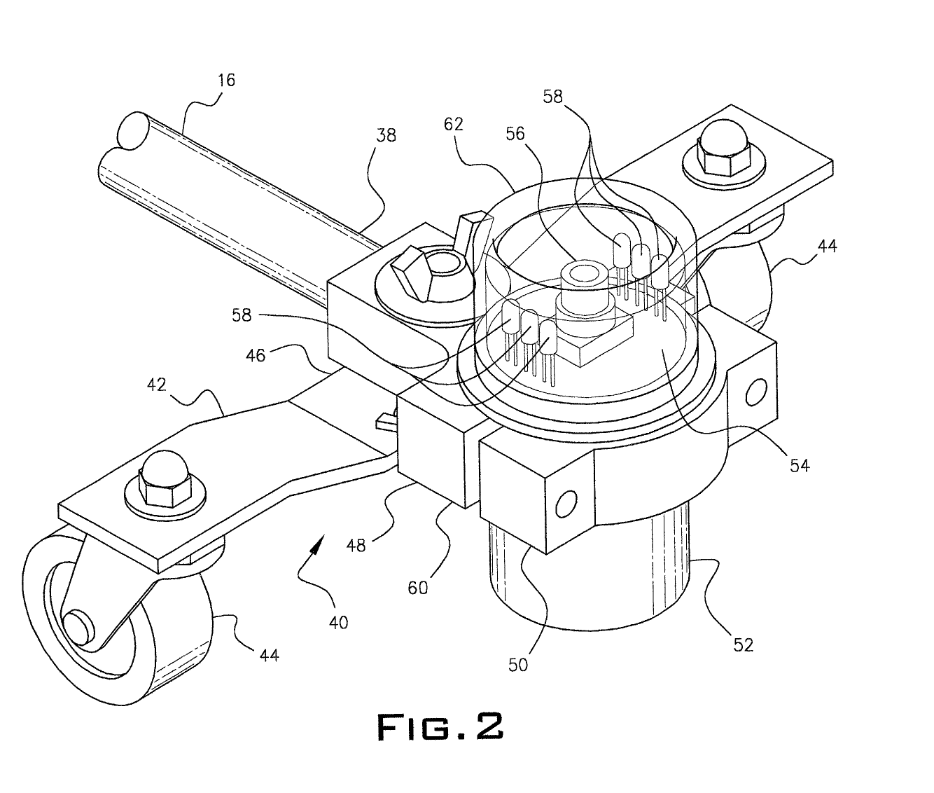

As shown in FIG. 1, rod lower leg member 16 also includes a second end 38 on which a head portion 40 is mounted. Head portion 40, as shown in FIG. 2, includes an elongated plate 42 mounted perpendicularly to rod lower leg member 16. A pair of castor wheels 44, mounted to a bottom side of elongated plate 42, permit head portion 40 to rotate about a 360° plane. Mounted at a center portion 46 of a top side of elongated plate 42, is a clamping mechanism 60 having a first and second part 48 and 50. Clamping mechanism 60 supports a tubular shaped housing 52 in which a circuit board 54 is mounted having a camera lens 56 and plurality of infrared diodes 58. Camera lens 56 is mounted perpendicularly in relation to circuit board 54 such that camera lens 56 points upwardly and through a transparent cover 62 of housing 52. Infrared diodes 58, mounted around camera lens 56, are also positioned perpendicularly in relation to circuit board 54 pointing upwardly and providing illumination for camera lens 56 in low light situations.

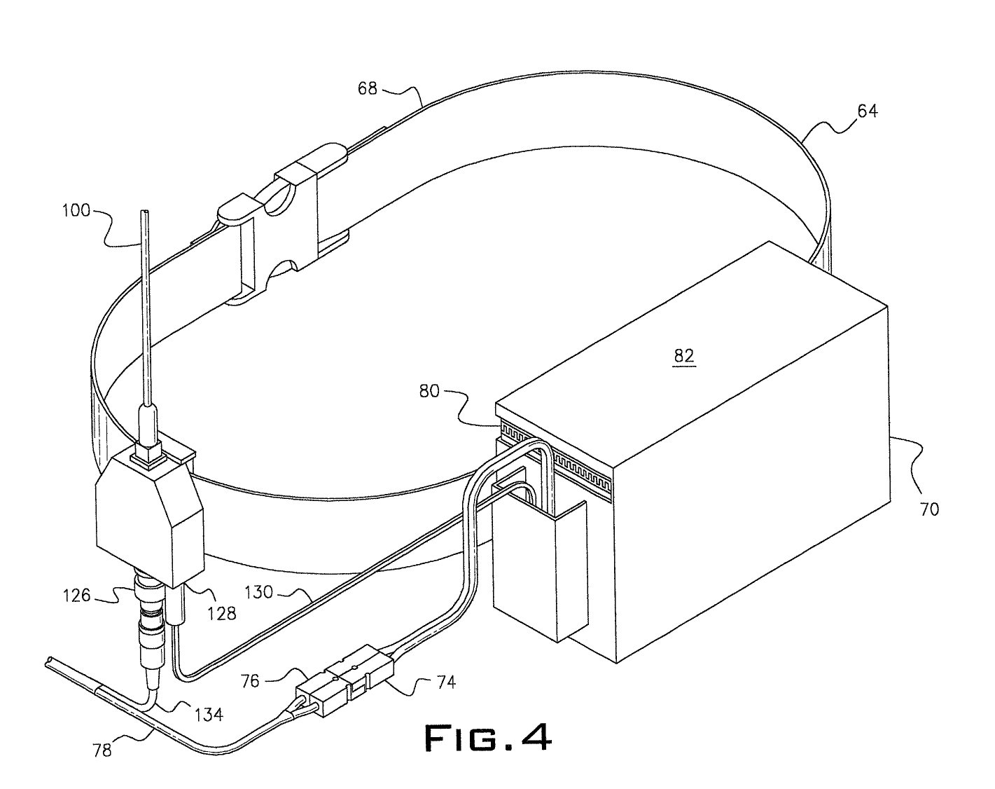

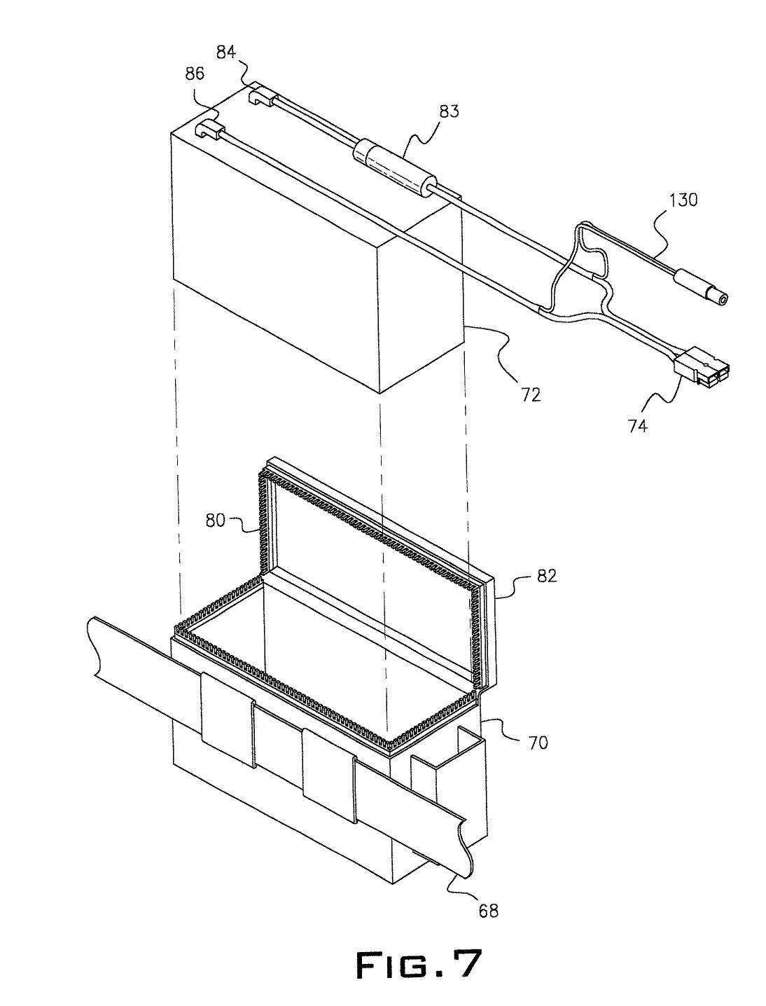

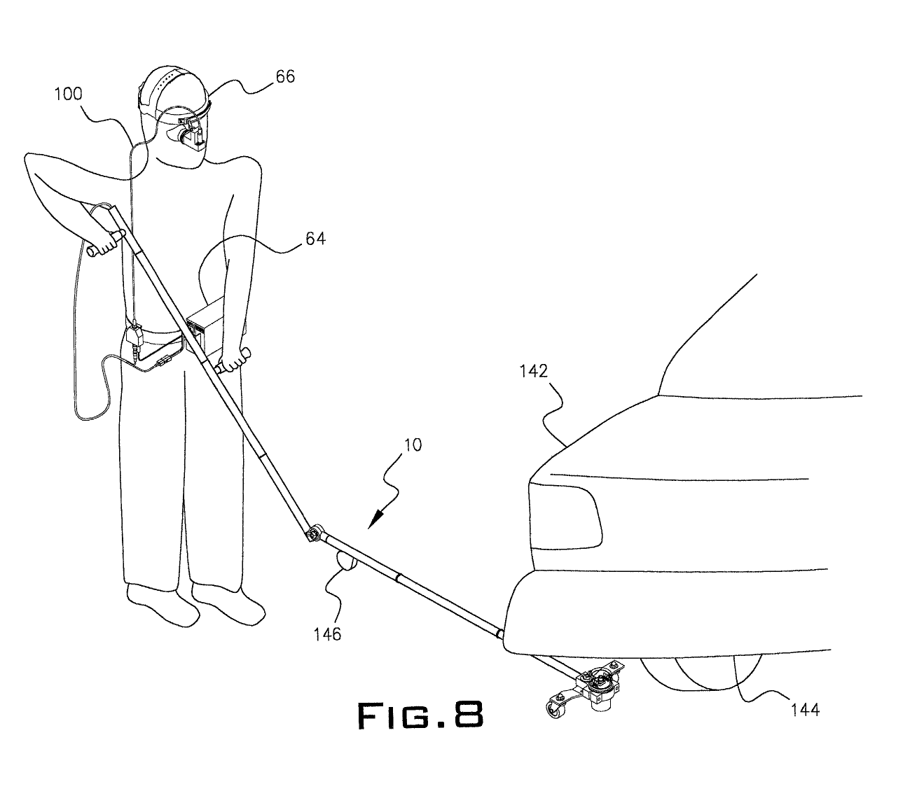

Referring again to FIG. 1, it is shown that vehicle inspection camera 10 also includes a battery pack belt 64 and headgear 66. As shown in FIG. 4, battery pack belt 64 includes an adjustable and removable belt 68, a battery pouch 70 and a battery 72 (see FIG. 7). Battery 72 provides a DC power source to camera lens 56 wherein a first connector 74 couples to a second connector 76 which in turn electrically couples to a power cable 78 which electrically couples to camera lens 56. As shown in FIG. 8, battery pack belt 64 can be worn by a user around the waist.

Referring to FIG. 7, it is shown that battery pouch 70 includes a zipper 80 for use in closing a top flap 82 of pouch 70. A fuse 83 is mounted in line with a positive pole 84 of battery 72. Although not shown, a small opening is formed in battery pouch 70 which permits power cables connected to positive pole 84 and a negative pole 86 of battery 72 to thread through pouch 70. Accordingly, as shown in FIG. 4, battery 72 can be enclosed within pouch 70 with top flap 82 closed by zipper 80 yet have the power cables extending thereout.

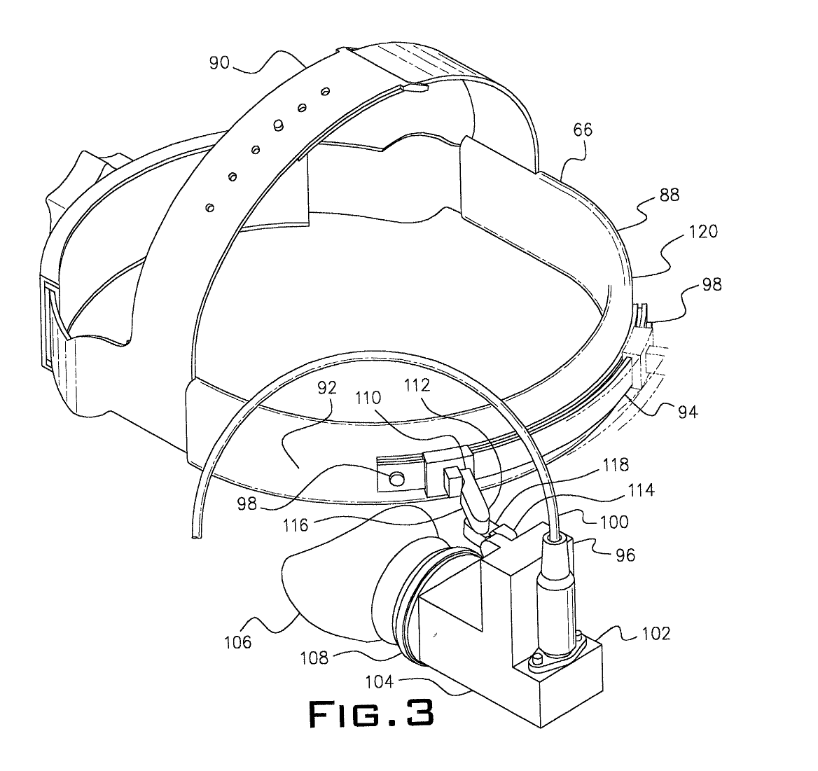

As shown in FIG. 3, headgear 66 includes an adjustable head band 88 and an adjustable skull strap 90 which both operate to affix headgear 66 to the head of user (see FIG. 8). Mounted along a front side 92 of head band 88 is a guide rail 94 for affixing a moveable eyepiece 96 thereto. As shown in FIG. 3, eyepiece 96 can be positioned anywhere along guide rail 94. However, eyepiece 96 is most often positioned at one of two opposed ends of guide rail 94 depending on which eye the user wishes to use to view the small screen (not shown) in eyepiece 96. A pair of stop members 98, one each mounted at each opposed end of guide rail 94, defines the limit that eyepiece 96 can be positioned at the respective ends. A video and power cable 100 extends from a distal end 102 of a body portion 104 of eyepiece 96 and provides a video signal and power source to eyepiece 96. A flexible and soft light cover 106 is provided at a proximal end 108 of eyepiece body portion 104 to reduce glare, to prohibit light from entering eyepiece 96 and to provide a soft resting element against the eye socket of the user when eyepiece 96 is being used. As set forth above, although not shown, a small video screen is located within an internal cavity of eyepiece 96 which is used to render a video image that is captured by camera lens 56.

With continuing reference to FIG. 3, is shown that eyepiece 96 can rotate about three separate axises (or rotation points), in addition to being moveable along guide rail 94, thereby permitting eyepiece 96 to be employed in a variety of different positions. This ensures that regardless of the shape or size of the head of the user, eyepiece 96 can be comfortably located for each and every user. Accordingly, headgear 66 is configured to be “one size fits all.” In particular, eyepiece 96 rotates up and down at a first rotation point 110, side-to-side at a second rotation point 112 and again up and a down at a third rotation point 114. A first arm 116 connects at a common end to a second arm 118 at second rotation point 112, whereas opposed ends of each arm, 116 and 118, connect to first and third rotation points, 110 and 114 respectively. Finally, as to headgear 66, as shown in FIG. 3, a strip of soft material 120 is wrapped around head band front side 92 thereby providing a comfortable fit to the user when headgear 66 is secured to the user's skull.

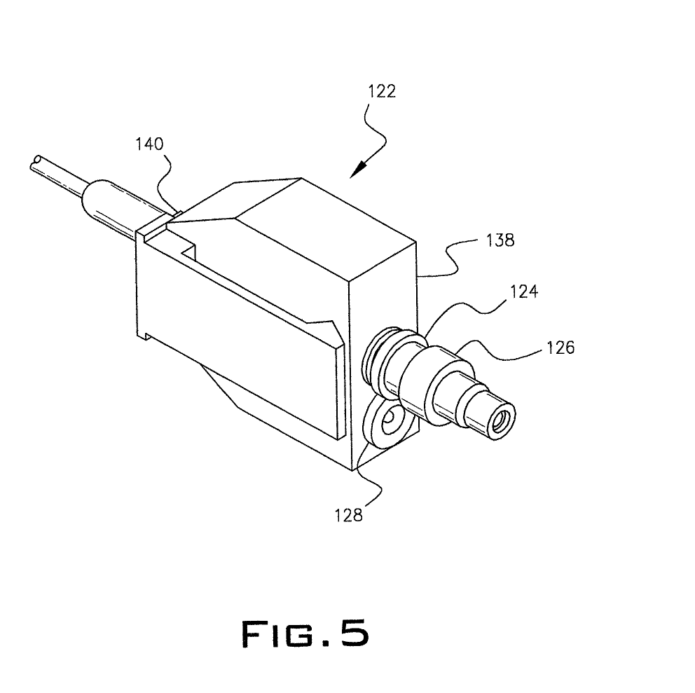

Referring to FIG. 1, it is shown that a video signal and power source distributing adapter 122 is provided which can be clipped onto battery pack belt 64. As shown in FIG. 5, distributing adapter 122 is provided with a 75 ohm video connection socket 124 on which a BNC to RCA adapter plug 126 is inserted thereover and a battery connection socket 128. As shown in FIG. 4, a battery lead 130 from battery 72 couples to distributing adapter battery connection socket 128, while an RCA plug 132 coupled to an end of a video signal cable 134, connected to camera lens 56, couples to RCA adapter plug 126. It can also be appreciated, as shown in FIG. 4, that video signal cable 134 and power cable 78 are wrapped together yet shielded from one another and secured to extendable rod 12 by tie straps 136 (see FIG. 1). Both 75 ohm connection socket 124 and battery connection socket 128 are located along a bottom portion 138 of distributing adapter 122. Video signal and power cable 100 connected to eyepiece 96 couples to distributing adapter 122 at a top end 140.

In the preferred embodiment, battery 72 is a rechargeable 12 volt battery. Accordingly, an AC power adapter (not shown) can be coupled to battery 72, when vehicle inspection camera 10 is not being used, at first connector 74 to recharge battery 72 through the use of an AC socket.

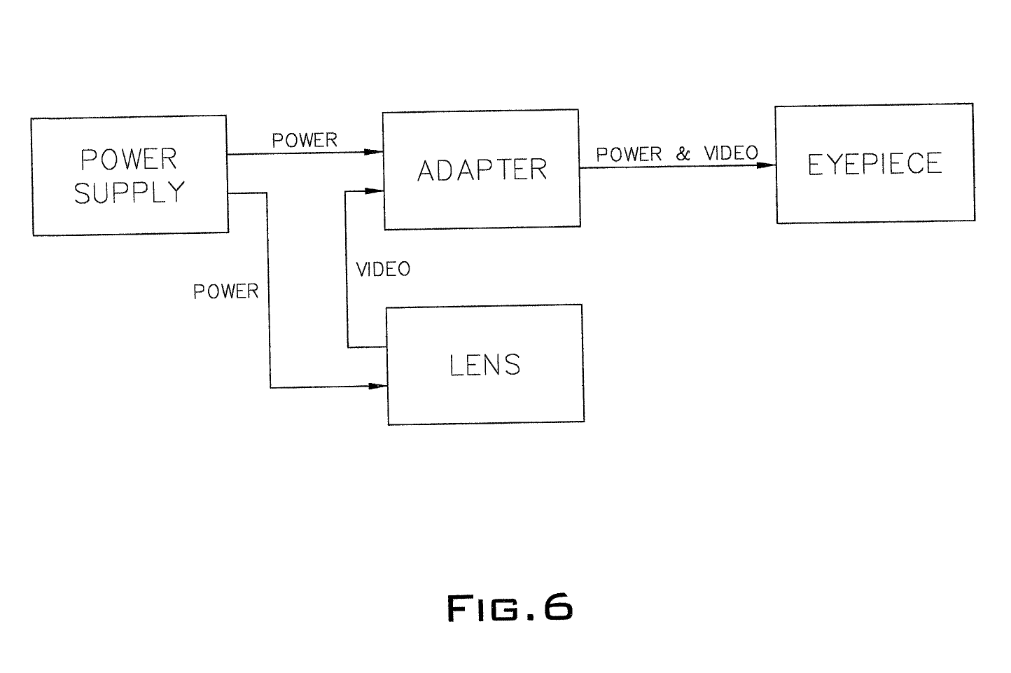

Referring to FIG. 6, a flow diagram is shown illustrating the connection of the electrical components of vehicle inspection camera 10. As such the block labeled as “power supply” is battery 72. The block labeled as “lens” is camera lens 56. The block labeled as “adapter” is video signal and power source distributing adapter 122. And finally, the block labeled as “eyepiece” is eyepiece 96.

As shown is FIG. 8, vehicle inspection camera 10 is used to inspect the undercarriage 144 of a vehicle 142. A user having headgear 66 mounted on his skull and battery belt pack 64 secured to his waste, grasps handles 20 and 22 and positions head portion 40 underneath vehicle 142. Camera lens 56 transmits a video signal to eyepiece 96 whereby the user can see what is underneath vehicle 142. A foot portion 146 can be used to rest upon a ground surface thereby stabilizing vehicle inspection camera 10 when is use.

Vehicle inspection camera 10, headgear unit 66 and battery belt pack 64 can all be stored in a flat container (not shown). Since rod 12 can rotate about elbow 18 to about 0°, upper leg member 14 can “fold” down upon lower leg member 16 for easy storage. The container can be made of a shock resistant material and include a foam interior to secure rod 12, headgear unit 66 and battery belt pack 64 in a tight position when the container is closed.

Equivalent elements can be substituted for the ones set forth above such that they perform the same function in the same way for achieving the same result.

Having thus described the invention what is claimed and desired to be secured by Letters Patent is:

1. A remote area viewing inspection device utilizing a video camera comprising:
a) an elongated rod having a top and bottom end;
b) the video camera mounted on the rod bottom end and capable of being positioned in the remote area to be viewed and inspected;
c) an adjustable headgear unit having an adjustable eyepiece mounted thereon, the eyepiece including a video monitor for viewing a video signal captured by the video camera, the video camera and video monitor connected by a video signal cable, the adjustable headgear unit capable of being worn by an operator of the inspection device on the head of their body; and
d) a power source connected to the video camera and video monitor.

2. The remote area viewing inspection device of claim 1, wherein the elongated rod comprises an upper and lower leg member separated by an elbow.

3. The remote area viewing inspection device of claim 2, wherein the elbow is adjustable.

4. The remote area viewing inspection device of claim 1, further comprising:
a) a head portion for supporting the video camera at the rod bottom end;
b) the head portion including an elongated plate mounted perpendicularly with respect to the rod bottom end, at least two wheels mounted on a bottom surface of the elongated plate and a clamping mechanism having a first and second part mounted at a center portion of the elongated plate;
c) the video camera mounted on a circuit board enclosed within a tubular housing having a transparent cover; and
d) the clamping mechanism first and second part securing the tubular housing in an upright position such that the video camera is positioned perpendicularly with respect to a ground surface when the wheels are flat upon the ground surface, the video camera viewing upwardly through the tubular housing transparent cover.

5. The remote area viewing inspection device of claim 1, further comprising a plurality of infrared diodes surrounding the video camera for illuminating the remote area to be viewed and inspected when there is low or no light present at the remote area.

6. The remote area viewing inspection device of claim 1, wherein the adjustable headgear unit includes an adjustable head band and an adjustable skull strap.

7. The remote area viewing inspection device of claim 6, wherein the adjustable headgear unit includes a guide rail mounted along a front side of the head band, the guide rail supporting the eyepiece and having a pair of stop members located at opposed ends thereof for defining the limit to which the eyepiece can be positioned along the guide rail.

8. The remote area viewing inspection device of claim 1, wherein the power source is a battery.

9. The remote area viewing inspection device of claim 8, further comprising:
a) an adjustable belt capable of being worn by the inspection device operator around the waist of their body; and
b) a pouch attached to the adjustable belt enclosing the battery.

10. The remote area viewing inspection device of claim 9, wherein the pouch includes a body portion having a closed bottom end, an open top end, a top edge of the top end, a zipper attached along the top edge, a top flap and an opening formed in a side wall thereof, the zipper for securing the top flap to the pouch body portion, the opening for permitting electrical leads attached to the battery to be threaded through the body portion and thereout.

11. The remote area viewing inspection device of claim 1, further comprising a video signal and power source distribution adapter having a first connector for coupling to the power source, a second connector for coupling to the video signal cable connected to the video camera, and a first cable enclosing a power source lead and a video signal lead and having a multi-pin plug disposed at a distal end for engaging the eyepiece and for supplying the captured video signal and the power source thereto.

12. The remote area viewing inspection device of claim 11, wherein the distribution adapter includes a housing and a clip mechanism for securing the housing to a belt worn by the inspection device operator.

13. The remote area viewing inspection device of claim 1, wherein the adjustable eyepiece includes a body portion having an internal channel in which the video monitor is mounted, a proximal and distal end, a light cover mounted on the body portion proximal end for prohibiting light from entering the internal channel when the light cover is placed up against an eye socket of the inspection device operator, a video signal receptacle located in the body portion distal end for receiving a plug of the video signal cable, and a plurality of rotation joints for permitting the eyepiece to be placed in a variety of positions.

14. The remote area viewing inspection device of claim 13, wherein the eyepiece includes three rotation joints, a first rotation joint located proximal to the eyepiece to headgear unit mounting position, a second rotation point located between the eyepiece to headgear unit mounting position and a top end of the eyepiece body portion, and a third rotation point located at the eyepiece body portion top end.

15. A remote area viewing inspection device utilizing a video camera comprising:
a) an elongated rod having an upper and lower leg member separated by an elbow, each leg member having a top and bottom end, the elbow connecting the lower leg member top end to the upper leg member bottom end;
b) a head portion for supporting the video camera mounted at the rod lower leg member bottom end, the head portion capable of being positioned in the remote area such that the video camera can view and inspect said remote area;
c) an adjustable headgear unit having an adjustable eyepiece mounted thereon, the eyepiece including a video monitor for viewing a video signal captured by the video camera, the video camera and video monitor connected by a video signal cable, the adjustable headgear unit capable of being worn by an operator of the inspection device on the head of their body; and
d) a power source connected to the video camera and video monitor.

16. The remote area viewing inspection device of claim 15, wherein the elbow is adjustable thereby permitting the rod upper and lower leg members to be positioned at varying angles with respect to one another.

17. The remote area viewing inspection device of claim 15, further comprising:
a) the head portion including an elongated plate mounted perpendicularly with respect to the rod lower leg member bottom end, at least two wheels mounted on a bottom surface of the elongated plate, and a clamping mechanism having a first and second part mounted at a center portion of the elongated plate;
b) a tubular housing having a transparent cover for enclosing a circuit board;
c) the video camera mounted on the circuit board; and
d) the clamping mechanism first and second part securing the tubular housing in an upright position such that the video camera is positioned perpendicularly with respect to a ground surface when the wheels are flat upon the ground surface, the video camera viewing upwardly through the tubular housing transparent cover.

18. The remote area viewing inspection device of claim 15, further comprising a plurality of infrared diodes surrounding the video camera for illuminating the remote area to be viewed and inspected when there is low or no light present at the remote area.

19. The remote area viewing inspection device of claim 15, wherein the adjustable headgear unit comprises:
a) a generally circular adjustable head band having a front side;
b) a convex-shaped adjustable skull strap connected to the head band at opposed ends of the skull strap; and
c) a guide rail mounted along the head band front side for supporting the eyepiece, the guide rail having a pair of stop members located at opposed ends thereof for defining the limit to which the eyepiece can be positioned along the guide rail.

20. The remote area viewing inspection device of claim 15, wherein the power source is a battery.

21. The remote area viewing inspection device of claim 20, wherein the battery is rechargeable.

22. The remote area viewing inspection device of claim 20, further comprising:
a) an adjustable belt capable of being worn by the inspection device operator around the waist of their body; and
b) a pouch attached to the adjustable belt for enclosing the battery, the pouch including a body portion having a closed bottom end, an open top end, a top edge of the top end, a zipper attached along the top edge, a top flap and an opening formed in a side wall thereof, the zipper for securing the top flap to the pouch body portion, the opening for permitting electrical leads attached to the battery to be threaded through the body portion and thereout.

23. The remote area viewing inspection device of claim 15, further comprising a video signal and power source distribution adapter having a housing, a first connector located in the housing for coupling to the power source, a second connector located in the housing for coupling to the video signal cable connected to the video camera, and a first cable attached to the housing for enclosing a power source lead and video signal lead and having a multi-pin plug disposed at a distal end for engaging the eyepiece and for supplying the captured video signal and the power source thereto.

24. The remote area viewing inspection device of claim 15, wherein the adjustable eyepiece includes a body portion having an internal channel in which the video monitor is mounted, a proximal and distal end, a light cover mounted on the body portion proximal end for prohibiting light from entering the internal channel when the light cover is placed up against an eye socket of the inspection device operator, a video signal receptacle located in the body portion distal end for receiving a plug of the video signal cable, and three rotation joints for permitting the eyepiece to be placed in a variety of positions, a first rotation joint located proximal to the eyepiece to headgear unit mounting position, a second rotation point located between the eyepiece to headgear unit mounting position, and a top end of the eyepiece body portion, and a third rotation point located at the eyepiece body portion top end.

25. The remote area viewing inspection device of claim 15, wherein the remote area to be viewed and inspected is the undercarriage of a vehicle.

26. The remote area viewing inspection device of claim 15, further comprising a foot member located proximal to the rod lower leg member top end, the foot member assisting in stabilizing the inspection device against a ground surface while being used.

27. The remote area viewing inspection device of claim 15, further comprising a pair of handles attached along the rod upper leg member at perpendicular angles to said upper leg member in opposed directions.

28. A vehicle inspection camera system for use in viewing the undercarriage of a vehicle, the camera system comprising:
a) an elongated rod having a top and bottom end;
b) a video camera mounted on the rod bottom end such that a lens of the video camera is disposed perpendicularly with respect to a flat ground surface on which the vehicle rests permitting the vehicle undercarriage to be viewed by the video camera lens;
c) a headgear unit having an eyepiece mounted thereto, the eyepiece including a video screen mounted within an internal cavity of the eyepiece, the video camera coupled to the video screen by a video signal cable; and
d) a portable power source coupled to the video camera and the video screen.

29. The vehicle inspection camera system of claim 28, wherein the elongated rod comprises an upper and lower leg member separated by an adjustable elbow.

30. The vehicle inspection camera system of claim 28, further comprising:
a) a head portion for supporting the video camera at the rod bottom end;
b) the head portion including an elongated plate mounted perpendicularly with respect to the rod bottom end, at least two wheels mounted on a bottom surface of the elongated plate, and a clamping mechanism having a first and second part mounted at a center portion of the elongated plate;
c) the video camera mounted on a circuit board enclosed within a tubular housing having a transparent cover; and
d) the clamping mechanism first and second part securing the tubular housing in an upright position such that the video camera views upwardly through the tubular housing transparent cover.

31. The vehicle inspection camera system of claim 30, further comprising a plurality of infrared diodes surrounding the video camera for illuminating the vehicle undercarriage when there is low or no light present thereunder.

32. The vehicle inspection camera system of claim 28, wherein the headgear unit comprises:
a) a generally circular adjustable head band having a front side;
b) a convex-shaped adjustable skull strap attached to the head band at opposed ends of the skull strap; and
c) a guide rail mounted along the head band front side, the guide rail supporting the eyepiece and having a pair of stop members located at opposed ends thereof for defining the limit to which the eyepiece can be positioned along the guide rail.

33. The vehicle inspection camera system of claim 28, further comprising:
a) the power source being a battery;
b) an adjustable belt capable of being worn by an operator of vehicle inspection camera system; and
c) a pouch attached to the adjustable belt enclosing the battery and having an opening formed therein for permitting electrical battery leads to be threaded out through the pouch.

34. The vehicle inspection camera system of claim 28, further comprising a video signal and power source distribution adapter having a first connector for coupling to the power source, a second connector for coupling to the video signal cable connected to the video camera, and a first cable enclosing a power source lead and a video signal lead and having a multi-pin plug disposed at a distal end for engaging the eyepiece and for supplying the captured video signal and the power source thereto.

35. The vehicle inspection camera system of claim 28, wherein the eyepiece is adjustable and includes a body portion surrounding the internal channel, a proximal and distal end, a light cover mounted on the body portion proximal end for prohibiting light from entering the internal channel when the light cover is placed up against an eye socket of an operator of the vehicle inspection camera, a video signal receptacle located in the body portion distal end for receiving a plug of the video signal cable, and a plurality of rotation joints for permitting the eyepiece to be placed in a variety of positions.

36. The vehicle inspection camera system of claim 35, wherein the adjustable eyepiece includes three rotation joints, a first rotation joint located proximal to the eyepiece to headgear unit mounting position, a second rotation point located between the eyepiece to headgear unit mounting position and a top end of the eyepiece body portion, and a third rotation point located at the eyepiece body portion top end.
